(19) United States
(12) Patent Application Publication
(10) Pub. No.: US 2026/0097423 A1
(43) Pub. Date: Apr. 9, 2026

(54) GLUE RESIDUE CLEANING MODULE AND ELECTRONIC COMPONENT ASSEMBLY SYSTEM

(71) Applicants: Sheng-Hung WANG, Taoyuan City (TW); Po-Hsiang CHANG, Taoyuan City (TW); Zhe-Min LIAO, Taoyuan City (TW)

(72) Inventors: Sheng-Hung WANG, Taoyuan City (TW); Po-Hsiang CHANG, Taoyuan City (TW); Zhe-Min LIAO, Taoyuan City (TW)

(21) Appl. No.: 19/334,875

(22) Filed: Sep. 21, 2025

(30) Foreign Application Priority Data
Sep. 30, 2024 (TW) 113137464

(51) Int. Cl. B08B 5/02; B08B 1/14

(52) U.S. Cl. CPC B08B 5/02; B08B 1/14

(57) ABSTRACT

The present invention provides a glue residue cleaning module and an electronic component assembly system for removing glue residue from an object. The glue residue cleaning module comprises a base and a glue residue accommodating portion. The base has an air inlet connector and at least one air-guiding slit. The air inlet connector is in fluid communication with said at least one air-guiding slit, which is disposed adjacent to a cleaning zone. The glue residue accommodating portion is detachably connected to the base and has at least one air outlet opening. In a vertical direction, the glue residue accommodating portion is located below the base. Said at least one air-guiding slit is configured to direct an airflow to impinge upon the object located in the cleaning zone, and the airflow exits the glue residue cleaning module through said at least one air outlet opening.

### CROSS REFERENCE TO RELATED APPLICATION

The present application claims priority to Taiwan patent application Serial No. 113137464 filed on Sep. 30, 2024 the entire content of which is incorporated by reference to this application.

### BACKGROUND OF THE INVENTION

### 1. Field of the Invention

The present invention relates to a cleaning module and an electronic component assembly system, and more particularly, to a cleaning module capable of removing glue residue and an electronic component assembly system utilizing said cleaning module.

### 2. Description of the prior art

To assemble a plurality of relatively small electronic components, adhesive is often applied between the components for fixation. Generally, to dispense the adhesive onto precise locations, the adhesive is loaded into a dispensing syringe and then extruded therefrom. Since the front end of the dispensing syringe is equipped with a fine glue needle, the adhesive extruded can accurately adhere to the position contacted by the glue needle. However, because the adhesive is viscous, some adhesive is likely to remain on the used glue needle. The adhesive remaining on the glue needle (i.e., glue residue) may affect the subsequent amount of adhesive dispensed from the needle or the accuracy of the dispensing location.

To remove the adhesive remaining on the glue needle, the conventional method involves manually rubbing the glue needle repeatedly against other surfaces to scrape off any potential residue. As those skilled in the art will appreciate, manually rubbing the glue needle is not only unsuitable for fully automated electronic component assembly systems but also risks damaging the needle through compression. Therefore, there is a need in the industry for a novel glue residue cleaning module that can not only automatically remove glue residue from the glue needle but also simultaneously address the problems associated with traditional rubbing methods.

### SUMMARY OF THE INVENTION

The present invention provides a glue residue cleaning module capable of utilizing an airflow to automatically remove glue residue from a glue needle, thereby eliminating the need to rub the needle against other objects and preventing damage to the needle.

The present invention provides a glue residue cleaning module disposed in an electronic component assembly system for removing glue residue from an object. The glue residue cleaning module comprises a base and a glue residue accommodating portion. The base has an air inlet connector and at least one air-guiding slit. The air inlet connector is in fluid communication with said at least one air-guiding slit, and said at least one air-guiding slit is disposed adjacent to a cleaning zone. The glue residue accommodating portion is detachably connected to the base and has at least one air outlet opening. In a vertical direction, the glue residue accommodating portion is located below the base. Said at least one air-guiding slit is configured to direct an airflow to impinge upon the object located in the cleaning zone, and the airflow exits the glue residue cleaning module through said at least one air outlet opening.

In some embodiments, the base may be formed with a through-hole portion that surrounds the cleaning zone, and the glue residue accommodating portion is located below the through-hole portion. Furthermore, said at least one air-guiding slit may be disposed at a periphery of the through-hole portion, and an opening of said at least one air-guiding slit faces toward the glue residue accommodating portion. Additionally, said at least one air-guiding slit may comprise a first air-guiding slit and a second air-guiding slit symmetrically disposed at the periphery of the through-hole portion.

In some embodiments, the glue residue accommodating portion may have a recess. The airflow enters the recess and subsequently exits the glue residue cleaning module through said at least one air outlet opening. Furthermore, a cleaning element may be replaceably disposed within the recess and is configured to collect glue residue entering the recess. Moreover, the cleaning element is made of a porous material, and at least part of the airflow enters the recess and passes through the cleaning element before exiting the glue residue cleaning module through said at least one air outlet opening.

In some embodiments, said at least one air outlet opening may comprise a first air outlet opening and a second air outlet opening symmetrically disposed on one of a side surface and a bottom surface of the glue residue accommodating portion. Furthermore, the glue residue cleaning module may further comprise a lifting element connected to the base. The lifting element is configured to move the base in the vertical direction so as to align said at least one air-guiding slit with different vertical positions of the cleaning zone.

The present invention provides an electronic component assembly system featuring a glue residue cleaning module that utilizes an airflow to automatically remove glue residue from a glue needle. Therefore, the electronic component assembly system eliminates the need to rub the glue needle against other objects, thereby achieving the objective of preventing damage to the needle.

The present invention provides an electronic component assembly system for removing glue residue from an object. The electronic component assembly system comprises a glue residue cleaning module and a lifting element. The glue residue cleaning module comprises a base and a glue residue accommodating portion. The base has an air inlet connector and at least one air-guiding slit. The air inlet connector is in fluid communication with said at least one air-guiding slit, and said at least one air-guiding slit is disposed adjacent to a cleaning zone. The glue residue accommodating portion is detachably connected to the base and has at least one air outlet opening. The lifting element is configured to move the object within the cleaning zone. When the lifting element moves the object within the cleaning zone, said at least one air-guiding slit is configured to direct an airflow to impinge upon the object, and the airflow subsequently exits the glue residue cleaning module through said at least one air outlet opening.

In summary, the glue residue cleaning module and the electronic component assembly system provided by the present invention can utilize an airflow to remove glue residue from a glue needle. Said glue residue can be automatically carried by the airflow to the glue residue accommodating portion to avoid contaminating the electronic components to be assembled. This enables the electronic component assembly system to achieve the objective of preventing damage to the glue needle without requiring manual rubbing.

### BRIEF DESCRIPTION OF THE APPTERMINALED DRAWINGS

FIG. 1 is a perspective schematic view of a glue residue cleaning module according to an embodiment of the present invention.

FIG. 2 is a perspective schematic view of a base according to an embodiment of the present invention.

FIG. 3 is another perspective schematic view of a base according to an embodiment of the present invention.

FIG. 4 is a perspective schematic view of a top cover according to an embodiment of the present invention.

FIG. 5 is a perspective schematic view of a bottom cover according to an embodiment of the present invention.

FIG. 6 is a cross-sectional schematic view of the base taken along line AA′ in FIG. 2.

FIG. 7 is a perspective schematic view of a glue residue accommodating portion according to an embodiment of the present invention.

FIG. 8 is a cross-sectional schematic view of the glue residue cleaning module taken along line BB′ in FIG. 1.

FIG. 9 is a top plan view of a bottom cover according to an embodiment of the present invention.

FIG. 10 is a top plan view of a bottom cover according to another embodiment of the present invention.

FIG. 11 is a top plan view of a bottom cover according to yet another embodiment of the present invention.

FIG. 12 is a block diagram of an electronic component assembly system according to an embodiment of the present invention.

FIG. 13 is a block diagram of an electronic component assembly system according to another embodiment of the present invention.

### DETAILED DESCRIPTION OF THE INVENTION

The features, targets, and functions of the present invention are further disclosed below. However, it is only a few of the possible embodiments of the present invention, and the scope of the present invention is not limited thereto; that is, the equivalent changes and modifications done in accordance with the claims of the present invention will remain the subject of the present invention. Without departing from the spirit and scope of the invention, it should be considered as further enablement of the invention.

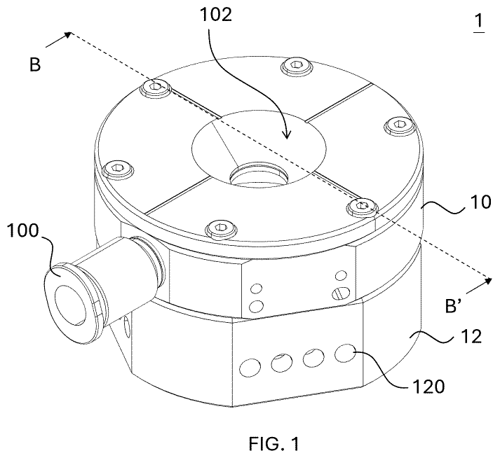

Please refer to FIG. 1, which is a perspective schematic view of a glue residue cleaning module according to an embodiment of the present invention. The glue residue cleaning module 1 can be disposed in an electronic component assembly system (not shown in FIG. 1), thereby becoming a part of the electronic component assembly system. The function of the glue residue cleaning module 1 is to remove glue residue from an object. In practice, if the electronic component assembly system includes dispensing equipment, such as a glue needle, then the glue residue cleaning module 1 can be used to remove glue residue adhering to the glue needle. The present embodiment does not limit the application field of the glue residue cleaning module 1. The objects to which the glue residue cleaning module 1 may be applied could be equipment other than glue needles; for example, the glue residue cleaning module 1 might be used in mechanical processing or model assembly scenarios. In other words, as long as it can be used to remove glue residue from any object, it should fall within the scope of the glue residue cleaning module 1 described in this embodiment. Furthermore, this embodiment does not limit the material or type of the glue residue; for example, the residue may be a viscous liquid, a substance between solid and liquid, or a material that has already dried and solidified on the object.

As shown in FIG. 1, the glue residue cleaning module 1 comprises a base 10 and a glue residue accommodating portion 12, which are detachably fixed together. In practice, the base 10 and the glue residue accommodating portion 12 can be secured together via threads or engaged with each other using snap-fit components, which is not limited in this embodiment. In one example, at least a portion of the base 10 extends into the glue residue accommodating portion 12. This extended portion of the base 10 not only helps stabilize the connection between the two but is also related to the flow path of the airflow inside the glue residue cleaning module 1, which will be described in later paragraphs of this embodiment. Furthermore, from the exterior view of the glue residue cleaning module 1 depicted in FIG. 1, it can be seen that the base 10 has an air inlet connector 100 and a through-hole portion 102, and the glue residue accommodating portion 12 has air outlet openings 120. The air inlet connector 100 is used to connect a pipe conveying airflow, receiving an airflow externally supplied into the glue residue cleaning module 1. Additionally, providing one or more air outlet openings 120 on the glue residue accommodating portion 12 allows the airflow to be discharged from the glue residue cleaning module 1. In other words, the airflow generally enters the base 10 from the air inlet connector 100 and exits the glue residue accommodating portion 12 via the air outlet openings 120. It is worth noting that said airflow is more inclined to exit the glue residue accommodating portion 12 through the air outlet openings 120 rather than exit the glue residue cleaning module 1 through the through-hole portion 102; the reasons for this will be explained in detail later in this embodiment.

In one example, the through-hole portion 102 is a hollow structure recessed into the base 10. An object can be placed into the base 10 from the upper opening of the through-hole portion 102. When the object is dispensing equipment, the glue needle at the front end of the dispensing equipment can enter the through-hole portion 102 from above to below in FIG. 1. That is to say, considering the vertical direction in FIG. 1, there will be relative displacement between the glue needle and the glue residue cleaning module 1, allowing a length of the glue needle to temporarily reside within the through-hole portion 102. This embodiment does not limit whether the glue needle moves towards the glue residue cleaning module 1 or the glue residue cleaning module 1 moves towards the glue needle; those skilled in the art can freely design according to the needs of the equipment. It is worth noting that, unlike the traditional method of physically rubbing to scrape residue off the glue needle, when using the glue residue cleaning module 1 of this embodiment, the glue needle does not contact the through-hole portion 102. This embodiment can use airflow to remove glue residue from the needle in a non-contact manner. For ease of explanation, the components of the glue residue cleaning module 1 will be separated and explained individually below.

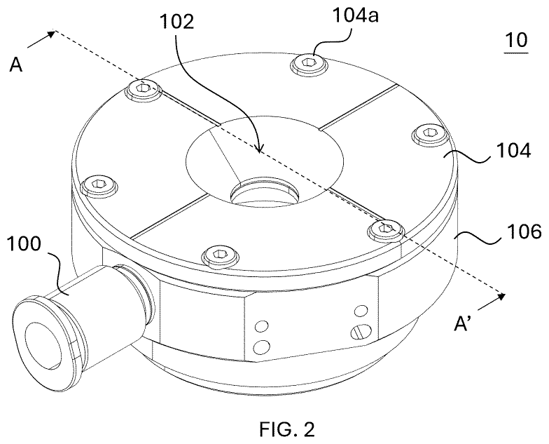

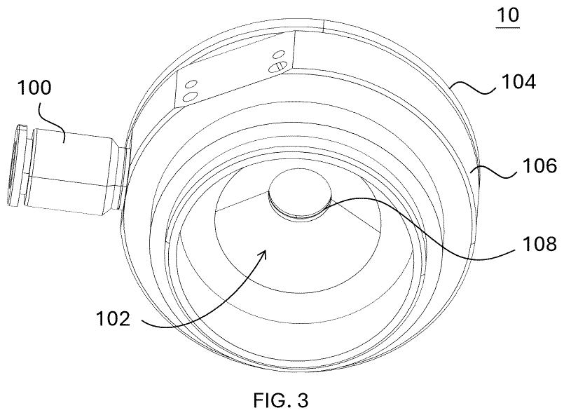

Please refer concurrently to FIGS. 1, 2, and 3. FIG. 2 is a perspective schematic view of a base according to an embodiment of the present invention, and FIG. 3 is another perspective schematic view of a base according to an embodiment of the present invention. FIGS. 2 and 3 view the base 10 from different angles, allowing for a clearer explanation of the structural features of the base 10. As shown, the base 10 can be composed of a top cover 104 and a bottom cover 106. The top cover 104 and bottom cover 106 can be assembled together, for example, by one or more fastening members 104a, which is not limited in this embodiment. Here, the central portions of both the top cover 104 and the bottom cover 106 are hollow, so together they constitute the through-hole portion 102. Moreover, as FIGS. 2 and 3 view the through-hole portion 102 from different sides of the base 10, it is clear that the through-hole portion 102 is a through-passing structure.

Additionally, the base 10 further has at least one air-guiding slit 108. In the example shown in this embodiment, the air-guiding slit 108 is formed jointly by the top cover 104 and the bottom cover 106, although this is not limiting. The main function of the air-guiding slit 108 is to eject the airflow that enters the base 10 from the air inlet connector 100. In practice, the opening direction of the air-guiding slit 108 faces toward the glue residue accommodating portion 12. Consequently, when the airflow is ejected from the air-guiding slit 108, it is more inclined to blow into the glue residue accommodating portion 12 and will not exit via the central opening of the top cover 104. In one example, due to Bernoulli's principle, when the airflow is ejected from the opening of the air-guiding slit 108 towards the glue residue accommodating portion 12, a low-pressure zone can be formed in the through-hole portion 102, potentially drawing external air in from the central opening of the top cover 104. For ease of understanding, the airflow referred to in this embodiment does not discuss the external air drawn in from the central opening of the top cover 104 but refers to the airflow entering the base 10 from the air inlet connector 100.

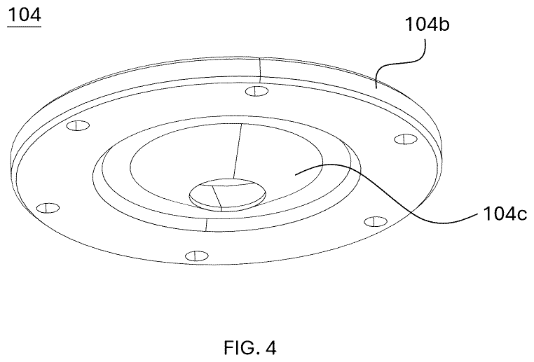

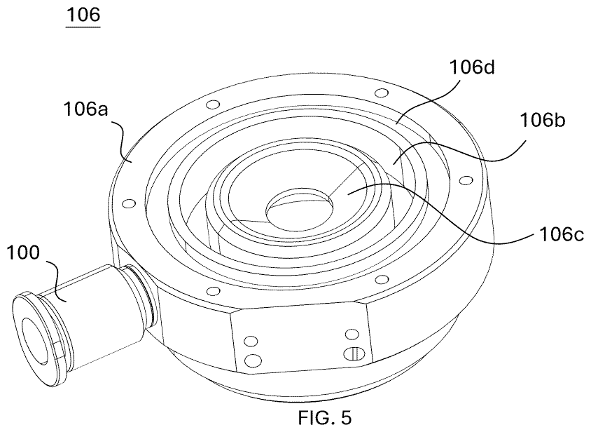

To explain the structure of the air-guiding slit 108 more clearly, please refer concurrently to FIGS. 1 through 5. FIG. 4 is a perspective schematic view of a top cover according to an embodiment of the present invention, and FIG. 5 is a perspective schematic view of a bottom cover according to an embodiment of the present invention. If the base 10 is disassembled, FIG. 2 shows the upper side of the top cover 104, while FIG. 4 shows the lower side of the top cover 104. As shown, besides having a top cover body 104b, the central portion of the top cover 104 appears funnel-shaped. Specifically, the top cover 104 has a circular opening in the middle, and the periphery of this opening is surrounded by a sloped surface 104c, causing the central portion of the top cover 104 to be recessed overall toward the lower side (or toward the bottom cover 106).

On the other hand, after removing the top cover 104 portion shown in FIG. 2, the internal structure of the bottom cover 106 can be seen. Here, besides having a bottom cover body 106a, the interior of the bottom cover body 106a has several groove-like structures. In practice, the air inlet connector 100 is connected to the bottom cover body 106a of the bottom cover 106, and the air inlet connector 100 communicates with an air-guiding groove 106b inside the bottom cover body 106a. FIG. 5 illustrates that the air-guiding groove 106b can be annular. After the airflow enters the air-guiding groove 106b from the air inlet connector 100, it will fill the air-guiding groove 106b according to its structure. Similar to the top cover 104, the bottom cover 106 also has a circular opening in the middle, and the periphery of this opening is surrounded by a sloped surface 106c. The sloped surface 104c of the top cover 104 and the sloped surface 106c of the bottom cover 106 do not contact each other; instead, they jointly form the air-guiding slit 108. Thus, after entering the air-guiding groove 106b, the airflow can then be ejected from the opening of the air-guiding slit 108 (between sloped surface 104c and sloped surface 106c).

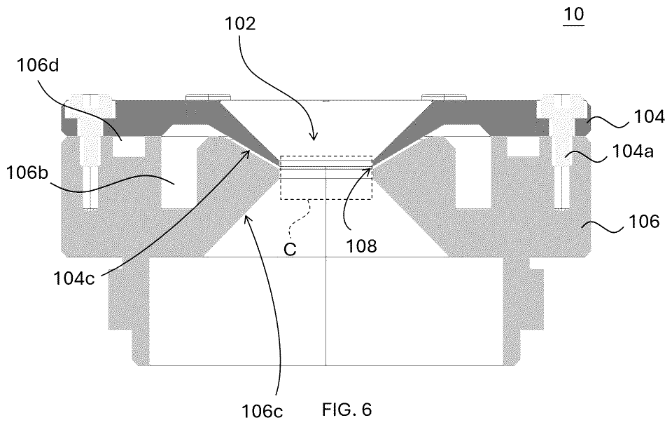

Please refer concurrently to FIGS. 1 through 6. FIG. 6 is a cross-sectional schematic view of the base taken along line AA′ in FIG. 2. To further clarify the structure of the air-guiding slit 108, this embodiment sections the base 10 shown in FIG. 2 along line AA′. As shown, the top cover 104 and the bottom cover 106 are marked with different colors in FIG. 6. The top cover 104 and the bottom cover 106 are fixed together by several fastening members 104a, which may be screws, though this is not limited herein. It can be seen that the sloped surface 104c of the top cover 104 and the sloped surface 106c of the bottom cover 106 are substantially parallel and have a gap between them without contact. In one example, the sloped surface 104c at the center of the top cover 104 can be viewed as a recess of the top cover 104.

Furthermore, the space between the top cover 104 and the air-guiding groove 106b of the bottom cover 106 forms an air chamber surrounding the through-hole portion 102. After the airflow enters the air-guiding groove 106b, it can only be ejected through the air-guiding slit 108 towards the through-hole portion 102. Since the opening of the air-guiding slit 108 faces the lower side of the base 10, said airflow does not flow towards the upper opening of the through-hole portion 102 but is instead ejected towards the lower opening of the through-hole portion 102. In practice, to ensure said airflow does not leak from the base 10 at places other than the air-guiding slit 108, the bottom cover 106 can also have a sealing groove 106d. In one example, an O-ring (not shown) can be placed in the sealing groove 106d of the bottom cover 106. When the top cover 104 and the bottom cover 106 are fastened together, the O-ring is compressed and deformed to fill the sealing groove 106d, allowing the sealing groove to block said airflow and ensure it is ejected only from the air-guiding slit 108.

It is worth noting that when a glue needle is placed into the through-hole portion 102, it should be inserted a certain distance so that it enters an effective cleaning zone C. This embodiment does not limit the actual location of the cleaning zone C. The cleaning zone C should refer to the area where the airflow ejected from the air-guiding slit 108 can effectively impact the glue residue on the needle. For example, the cleaning zone C can be substantially located along the extension line of the air-guiding slit 108. Thereby, the airflow ejected from the air-guiding slit 108 can effectively impact the glue needle located in the cleaning zone C. In actual use, the glue needle can first be placed into the cleaning zone C within the through-hole portion 102, and then the airflow can be ejected from the air-guiding slit 108 to impact the needle, preventing the glue residue on the needle from splattering. In practice, the extension line of the air-guiding slit 108 is oriented downward (toward the location of the glue residue accommodating portion 12). That is to say, as long as the top cover 104 and the bottom cover 106 have their respective sloped surfaces 104c and 106c facing downward, the extension line of the air-guiding slit 108 formed by these sloped surfaces will also face downward.

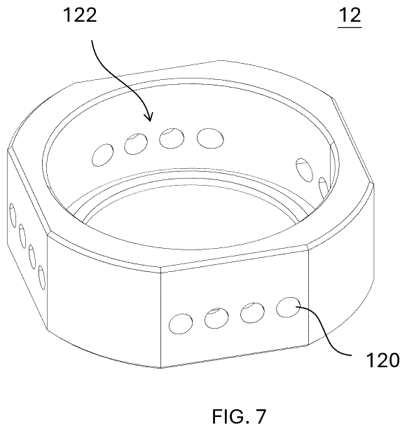

When the glue residue on the needle is blown off by the airflow, the glue residue accommodating portion 12 below the base 10 can collect the falling residue. For ease of explanation, please refer concurrently to FIGS. 1 through 7. FIG. 7 is a perspective schematic view of a glue residue accommodating portion according to an embodiment of the present invention. As shown, the glue residue accommodating portion 12 is a structure with a recess. Besides having one or more air outlet openings 120 on the side of the recess, the interior of the recess can be regarded as an accommodation region 122. This accommodation region 122 communicates with the base 10 to receive glue residue falling from the base 10. In practice, the airflow blown from the air-guiding slit 108 will first pass through the accommodation region 122 before exiting the glue residue accommodating portion 12 through the air outlet openings 120. In one example, to prevent the glue residue from being disturbed by the airflow after falling into the accommodation region 122, a cleaning element can be installed in the accommodation region 122. Said cleaning element can be a porous material that can more effectively capture and adsorb glue residue. For example, the porous material can be a type of sponge, although this is not limited in this embodiment. One reason for providing a cleaning element in the accommodation region 122 is that after glue residue falls into the accommodation region 122, it can be collected by the cleaning element and will not be blown up again by the airflow later. Of course, if the glue residue accommodating portion 12 is sufficiently large or the accommodation region 122 is sufficiently deep, making it difficult for the residue to be blown up again by airflow, then the interior of the glue residue accommodating portion 12 in this embodiment may not require a cleaning element.

In a practical example, the falling glue residue is influenced by various forces such as gravity and airflow. If the density of the residue is relatively high or it is more influenced by gravity when falling, the residue generally falls straight downward after leaving the needle. In this case, the cleaning element only needs to be placed at the bottom of the accommodation region 122. If the density of the residue is relatively low or it is more influenced by airflow when falling, the falling position after leaving the needle is less predictable. In this case, a larger cleaning element can be used, allowing part or all of the airflow to first flow through the cleaning element before exiting the glue residue accommodating portion 12 through the air outlet openings 120. This ensures the glue residue will be retained within the glue residue accommodating portion 12.

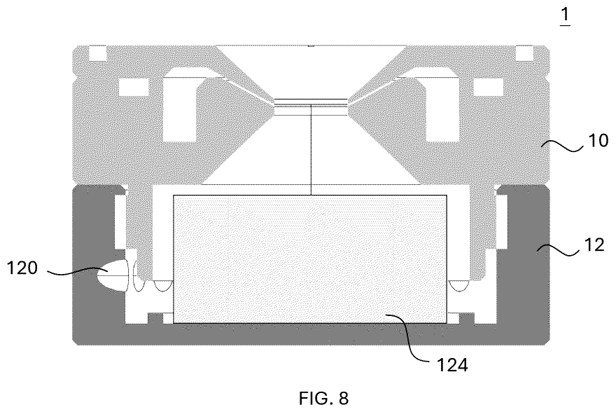

For ease of explanation, please refer concurrently to FIG. 1 and FIG. 8. FIG. 8 is a cross-sectional schematic view of the glue residue cleaning module taken along line BB′ in FIG. 1. As shown, when the base 10 and the glue residue accommodating portion 12 are assembled, assuming a cleaning element is installed inside the glue residue accommodating portion 12, then the cleaning element 124 can be placed close to the base 10 to maximally catch the falling residue. At this point, after the airflow blows from the base 10 into the glue residue accommodating portion 12, most of the airflow will first enter the cleaning element 124. Assuming some residue is carried along by the airflow, then as the airflow enters the cleaning element 124, the residue will also be collected by the cleaning element 124. Only the airflow will exit the glue residue accommodating portion 12 through the air outlet openings 120.

It is worth noting that when the base 10 and the glue residue accommodating portion 12 are assembled, a portion of the base 10 actually fits into the glue residue accommodating portion 12. FIG. 8 illustrates that this portion of the base 10, being inside the glue residue accommodating portion 12, can obstruct the path for airflow to blow directly from the air-guiding slit 108 to the air outlet openings 120. In particular, the airflow slows down due to the obstruction from the base 10 and the cleaning element 124, making it easier for the residue to separate from the airflow and fall into the glue residue accommodating portion 12. In practice, after the glue residue accommodating portion 12 (or the cleaning element inside it) is full of residue, one only needs to detach the base 10 and the glue residue accommodating portion 12 to easily clean the glue residue accommodating portion 12 or replace the cleaning element inside it, achieving the purpose of reusing the glue residue cleaning module 1. Furthermore, the glue residue accommodating portion 12 can have multiple air outlet openings 120, arranged symmetrically or at equal intervals around the periphery of the glue residue accommodating portion 12, thereby effectively guiding the airflow out of the glue residue accommodating portion 12.

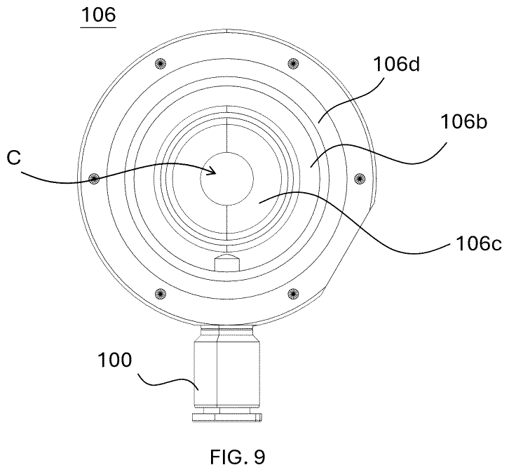

Please refer concurrently to FIG. 5 and FIG. 9. FIG. 9 is a top plan view of a bottom cover according to an embodiment of the present invention. As shown, FIG. 9 looks down on the bottom cover 106 of FIG. 5 from above. It can be seen that from the outside inward, the bottom cover 106 has the outermost sealing groove 106d, then the air-guiding groove 106b, and finally the innermost sloped surface 106c. The cleaning zone C is within the area surrounded by the sloped surface 106c. In a practical example, when airflow enters the air-guiding groove 106b from the air inlet connector 100, it fills the annular air-guiding groove 106b and is ejected from the air-guiding slit (in the direction of the sloped surface 106c). Those skilled in the art will understand that an annular air-guiding groove 106b means that a glue needle within the cleaning zone C at the center of the bottom cover 106 can generally be impacted by airflow from 360 degrees. In other words, as long as the glue needle enters the cleaning zone C, there should be a certain cleaning effect. However, the air-guiding groove may not be annular, so when the airflow is ejected from the air-guiding slit 108, the glue needle in the cleaning zone C may be impacted by unidirectional or multi-directional airflow.

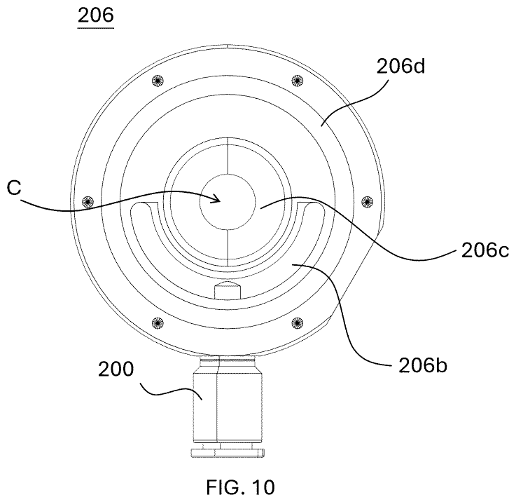

Please refer concurrently to FIGS. 9 and 10. FIG. 10 is a top plan view of a bottom cover according to another embodiment of the present invention. As shown, the similarity between FIGS. 9 and 10 is that the bottom cover 206 shown in FIG. 10 also has, from the outside inward, the outermost sealing groove 206d, then the air-guiding groove 206b, and finally the innermost sloped surface 206c. The cleaning zone C is within the area surrounded by the sloped surface 206c. The difference between FIGS. 9 and 10 is that the air-guiding groove 206b in FIG. 10 is not annular. In a practical example, when airflow enters the air-guiding groove 206b from the air inlet connector 200, ultimately only about half of the air-guiding slit (the portion adjacent to the air-guiding groove 206b) will have airflow ejected. Those skilled in the art will understand that a near semi-annular air-guiding groove 206b reduces the effective width of the air-guiding slit because only the portion of the slit near the air-guiding groove 206b ejects airflow. At the same time, this also means that a glue needle within the cleaning zone C at the center of the bottom cover 206 is not impacted by airflow from 360 degrees. For example, while the overall airflow is still directed toward the glue residue accommodating portion, it is also biased toward the upper side direction in the top view of FIG. 10. However, although the design of the semi-annular air-guiding groove 206b prevents airflow from impacting the needle from all directions, as long as the airflow is sufficiently strong, it does not hinder the purpose of removing residue from the glue needle.

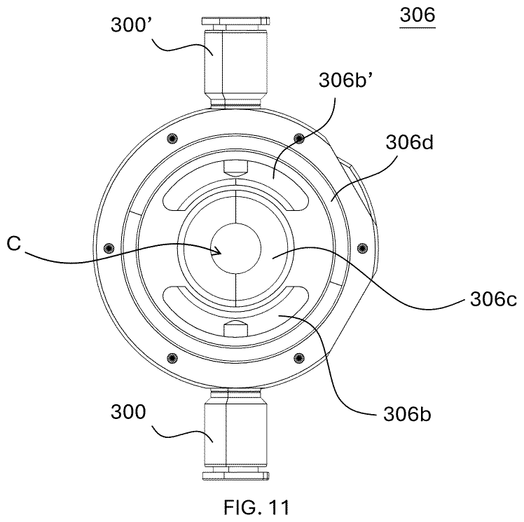

Please refer concurrently to FIGS. 10 and 11. FIG. 11 is a top plan view of a bottom cover according to yet another embodiment of the present invention. As shown, the similarity between FIGS. 10 and 11 is that the bottom cover 306 shown in FIG. 11 also has, from the outside inward, the outermost sealing groove 306d, then an air-guiding groove 306b, and finally the innermost sloped surface 306c. The cleaning zone C is within the area surrounded by the sloped surface 306c, and the air-guiding groove 306b is similarly not annular. The difference between FIGS. 10 and 11 is that, besides the air inlet connector 300 and the air-guiding groove 306b, FIG. 11 also has another set comprising an air inlet connector 300′ and an air-guiding groove 306b′. Those skilled in the art will understand that when the bottom cover 306 is combined with a top cover identical to FIG. 4, airflow will only be ejected from the areas adjacent to the air-guiding grooves 306b and 306b′, equivalent to having two air-guiding slits (a first air-guiding slit and a second air-guiding slit). As described for the example in FIG. 10, the airflow entering the air-guiding groove 306b (first air-guiding slit) from the air inlet connector 300, while overall directed toward the glue residue accommodating portion, is also biased toward the upper side direction in the top view of FIG. 11. On the other hand, the airflow entering the air-guiding groove 306b′ (second air-guiding slit) from the air inlet connector 300′, while overall directed toward the glue residue accommodating portion, is biased toward the lower side direction in the top view of FIG. 11. In other words, the air-guiding grooves 306b and 306b′ arranged on two sides in FIG. 11 indicate that a glue needle within the cleaning zone C will be impacted by airflow from both the upper and lower sides in FIG. 11, thereby improving the efficiency of removing residue from the needle.

It is worth noting that in the examples illustrated in FIGS. 1 through 8, when the air-guiding slit 108 ejects said airflow to impact the glue needle, the needle can be slowly withdrawn from the through-hole portion 102 (leaving the cleaning zone C), allowing said airflow to impact different positions on the needle to completely remove the residue. Of course, this embodiment does not limit the method to slowly withdrawing the needle from the through-hole portion 102; moving the base 10 without moving the needle can also achieve a similar effect by causing the needle to slowly leave the through-hole portion 102 relatively. In other words, at least one of the base 10 or the glue needle can be connected to a lifting element (not shown), allowing the lifting element to drive the base 10 or the glue needle so that they move relative to each other. On the other hand, the angle at which the glue needle is inserted into the through-hole portion 102 can be adjusted arbitrarily. For example, whether the needle enters the cleaning zone C within the through-hole portion 102 vertically or at an incline, it can be impacted by the airflow, causing the residue to be blown off. To obtain stronger airflow, those skilled in the art will understand that the cross-sectional area through which the air-guiding slit 108 allows airflow to pass should be smaller than the cross-sectional area through which the air inlet connector 100 allows airflow to pass, in order for the air-guiding slit 108 to increase the velocity of the ejected airflow.

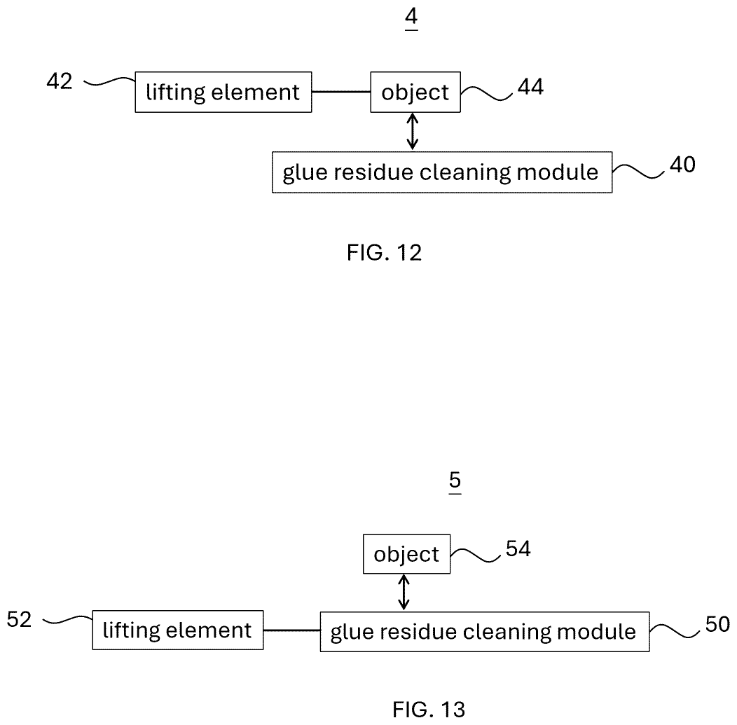

Following the above, when placing the aforementioned glue residue cleaning module into an electronic component assembly system, one can refer to FIGS. 12 and 13. FIG. 12 is a block diagram of an electronic component assembly system according to an embodiment of the present invention, and FIG. 13 is a block diagram of an electronic component assembly system according to another embodiment of the present invention. As shown in FIG. 12, the electronic component assembly system 4 has a glue residue cleaning module 40 and a lifting element 42. FIG. 12 demonstrates the scenario where the glue residue cleaning module 40 is stationary, and the object 44 (e.g., a glue needle) can be moved by the lifting element 42. This corresponds to the aforementioned example where, when the air-guiding slit ejects the airflow to impact the needle, the needle can be slowly withdrawn, allowing the airflow to impact different positions on the needle.

On the other hand, as shown in FIG. 13, the electronic component assembly system 5 similarly has a glue residue cleaning module 50 and a lifting element 52. FIG. 13 demonstrates the scenario where the glue residue cleaning module 50 can be moved by the lifting element 52, while the object 54 (e.g., a glue needle) is stationary. This corresponds to the aforementioned example where, when the air-guiding slit ejects the airflow to impact the glue needle, withdrawing the glue residue cleaning module 50 away from the needle can also allow the airflow to impact different positions on the needle.

In summary, the glue residue cleaning module and the electronic component assembly system provided by the present invention can utilize airflow to remove glue residue from a glue needle. Said glue residue can be automatically carried by the airflow to the glue residue accommodating portion to avoid contaminating the electronic components to be assembled. This enables the electronic component assembly system to achieve the objective of preventing damage to the glue needle without requiring manual rubbing.

What is claimed is:

1. A glue residue cleaning module disposed in an electronic component assembly system for removing glue residue from an object, the glue residue cleaning module comprising:
a base having an air inlet connector and at least one air-guiding slit, the air inlet connector being in fluid communication with the at least one air-guiding slit, and the at least one air-guiding slit being disposed adjacent to a cleaning zone; and
a glue residue accommodating portion detachably connected to the base and having at least one air outlet opening;
wherein, in a vertical direction, the glue residue accommodating portion is located below the base;
wherein the at least one air-guiding slit is configured to direct an airflow to impinge upon the object located in the cleaning zone, and the airflow exits the glue residue cleaning module through the at least one air outlet opening.

2. The glue residue cleaning module according to claim 1, wherein the base defines a through-hole portion that surrounds the cleaning zone, and the glue residue accommodating portion is located below the through-hole portion.

3. The glue residue cleaning module according to claim 2, wherein the at least one air-guiding slit is disposed at an inner edge of the through-hole portion, and an opening of the at least one air-guiding slit faces toward the glue residue accommodating portion.

4. The glue residue cleaning module according to claim 2, wherein the at least one air-guiding slit comprises a first air-guiding slit and a second air-guiding slit symmetrically disposed at the inner edge of the through-hole portion.

5. The glue residue cleaning module according to claim 1, wherein the glue residue accommodating portion has a recess, the airflow entering the recess and subsequently exiting the glue residue cleaning module through the at least one air outlet opening.

6. The glue residue cleaning module according to claim 5, wherein a cleaning element is replaceably disposed in the recess and is configured to collect glue residue entering the recess.

7. The glue residue cleaning module according to claim 6, wherein the cleaning element comprises a porous material, and at least part of the airflow passes through the cleaning element before exiting through the at least one air outlet opening.

8. The glue residue cleaning module according to claim 1, wherein the at least one air outlet opening comprises a first air outlet opening and a second air outlet opening symmetrically disposed on one of a side surface and a bottom surface of the glue residue accommodating portion.

9. The glue residue cleaning module according to claim 1, further comprising a lifting element connected to the base and configured to move the base in the vertical direction so as to align the at least one air-guiding slit with different vertical positions of the cleaning zone.

10. An electronic component assembly system for removing glue residue from an object, the electronic component assembly system comprising:
a glue residue cleaning module comprising:
a base having an air inlet connector and at least one air-guiding slit, the air inlet connector being in fluid communication with the at least one air-guiding slit, and the at least one air-guiding slit being adjacent to a cleaning zone; and
a glue residue accommodating portion detachably connected to the base and having at least one air outlet opening; and
a lifting element configured to move the object within the cleaning zone;
wherein when the lifting element moves the object within the cleaning zone, the at least one air-guiding slit directs an airflow to impinge upon the object, and the airflow subsequently exits the glue residue cleaning module through the at least one air outlet opening.

11. The electronic component assembly system according to claim 10, wherein the base defines a through-hole portion that surrounds the cleaning zone, and the glue residue accommodating portion is located below the through-hole portion.

12. The electronic component assembly system according to claim 11, wherein the at least one air-guiding slit is disposed at a periphery of the through-hole portion, and an opening of the at least one air-guiding slit faces toward the glue residue accommodating portion.

13. The electronic component assembly system according to claim 11, wherein the at least one air-guiding slit comprises a first air-guiding slit and a second air-guiding slit symmetrically disposed at the periphery of the through-hole portion.

14. The electronic component assembly system according to claim 10, wherein the glue residue accommodating portion has a recess, the airflow entering the recess and subsequently exiting the glue residue cleaning module through the at least one air outlet opening.

15. The electronic component assembly system according to claim 14, wherein a cleaning element is replaceably disposed in the recess and is configured to collect glue residue entering the recess.

16. The electronic component assembly system according to claim 15, wherein the cleaning element is made of a porous material, and the airflow passes through the cleaning element before exiting through the at least one air outlet opening.

17. The electronic component assembly system according to claim 10, wherein the at least one air outlet opening comprises a first air outlet opening and a second air outlet opening symmetrically disposed on one of a side surface and a bottom surface of the glue residue accommodating portion.
